(19) United States
(12) Patent Application Publication
(10) Pub. No.: US 2013/0026213 A1
(43) Pub. Date: Jan. 31, 2013

(54) WATERBORNE AUTOWELDABLE SHOP PRIMER

(71) Applicant: Valspar Sourcing, Inc., Minneapolis, MN (US)

(72) Inventors: James A. Prevost, Minneapolis, MN (US); Channing Charles Beaudry, Minneapolis, MN (US); Donald W. Boespflug, Minneapolis, MN (US); David J. Fouquette, Minneapolis, MN (US); David K. Black, Minneapolis, MN (US)

(73) Assignee: VALSPAR SOURCING, INC., Minneapolis, MN (US)

(21) Appl. No.: 13/644,920

(22) Filed: Oct. 4, 2012

Related U.S. Application Data
(63) Continuation of application No. PCT/US2011/031628, filed on Apr. 7, 2011.
(60) Provisional application No. 61/434,373, filed on Jan. 19, 2011.
(60) Provisional application No. 61/322,795, filed on Apr. 9, 2010.

(51) Int. Cl. B32B 15/08; B23K 31/02; B32B 15/092; B32B 15/082; B32B 15/09

(52) U.S. Cl. 228/262.1; 428/457; 428/461; 428/418; 428/458

(57) ABSTRACT

A one-part, storage-stable, air-dryable, latex-coatable waterborne film-forming coating composition has dispersed therein sufficient conductive material to provide an autoweldable hardened shop primer layer when applied to metal components. The thus-primed components may be welded together using automated arc welding equipment without having to remove the coating composition at the weld site. The conductive material desirably causes little or no airborne emission of unsafe quantities of heavy metals or other harmful substances when the primer is volatilized or combusted during welding.

### FIELD

This invention relates to coating compositions.

### BACKGROUND

Large metal objects such as cargo containers typically are assembled by welding together a number of individual components made of iron, steel or other conductive metals. To prevent the components from corroding prior to assembly while still enabling them to be welded together, the components may be cleaned (e.g., by shot blasting, grinding or other abrasive or ablative process) and then coated with a conductive, corrosion-inhibiting temporary primer. The thus-primed components desirably are welded (e.g., arc-welded) through the primer layer, without having to remove primer near the weld. Following welding, the primer may be removed from the area near the weld bead (again by shot blasting, grinding or other abrasive or ablative process) to permit slag removal and weld inspection. The inspected area may be overcoated with a further primer (e.g., a nonconductive primer) and then overcoated promptly thereafter with a suitable topcoat.

Welding may be performed using manual or automated welding equipment. Automatic welders may for example conveniently be used to weld containers or other standard assemblies where repetitive assembly steps are common. Manual welding equipment may for example conveniently be used to weld ships or other objects where repetitive assembly steps may be less common. Automatic welders are prone to malfunctioning when the conductivity of the surface to be welded varies unduly along the weld line. Defects arising out of such malfunctioning may include holes burned through the metal by elevated welding heat, and localized failure to form a weld due to non-detection of the metal.

Currently-used weldable temporary primers, sometimes called weldable shop primers, typically are solvent-based two-part zinc-rich epoxy compositions applied for example at a 0.005 to 0.02 mm coating thickness. A two-part water-based zinc-containing shop primer (Interplate Zero™ from Akzo Nobel) is used in some jurisdictions.

From the foregoing, it will be appreciated that what is needed in the art are improved shop primers. Such compositions and methods for their use are disclosed and claimed herein.

### SUMMARY OF THE INVENTION

The above-mentioned solvent-based two-part zinc-rich epoxy shop primers may have undesirably high volatile organic compound (VOC) levels (e.g., 0.5 Kg/L or more), may be slow to dry or harden, or may be difficult to remove from the area near a weld bead. The above-mentioned Interplate Zero shop primer has limited pot life once the two parts are mixed. Zinc powder can react with water to form hydrogen which may present an explosion hazard. In addition, welding through zinc-based primers may cause metal fume fever or other harmful conditions.

The present invention provides, in one aspect, a coated metal component comprising a weldable metal substrate having thereon a shop primer layer comprising a one-part, storage-stable, air-dryable, latex-coatable waterborne film-forming coating composition having dispersed therein sufficient conductive material to provide an autoweldable hardened shop primer layer.

The invention provides, in another aspect, a coated metal article comprising a plurality of metal components having thereon a corrosion-inhibiting primer film comprising a hardened waterborne binder having dispersed therein conductive material, the components being joined together by one or more defect-free welds through the hardened primer, and wherein if the conductive material comprises conductive zinc material, the amount thereof is sufficiently low so that the unhardened primer is a storage-stable liquid coating composition.

The invention provides, in yet another aspect, a method for assembling a metal article, which method comprises:
a) providing a plurality of metal components having thereon a corrosion-inhibiting primer film comprising a hardened waterborne binder and having dispersed therein sufficient conductive material so that the components may be autowelded through the primer, wherein if the conductive material comprises conductive zinc material, the amount thereof is sufficiently low so that the unhardened primer is a storage-stable liquid coating composition, and
b) welding the components together.

The disclosed shop primer facilitates assembly of metal components by welding and especially by autowelding without undesired holes or non-welded areas in weld beads.

### BRIEF DESCRIPTION OF THE DRAWING

FIG. 1 is a cross-sectional view of a butt-welded article of the invention;

FIG. 2 is a cross-sectional view of a tee-welded article of the invention;

FIG. 3 is a perspective end view of a shipping container of the invention; and

FIG. 4 is a perspective end view of a refrigerated shipping container of the invention.

Like reference symbols in the various figures of the drawing indicate like elements. The elements in the drawing are not to scale.

### DETAILED DESCRIPTION

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, a coating composition that contains “an” additive means that the coating composition includes “one or more” additives.

The term “air-dryable” when used with respect to a coating composition means that an applied layer of the composition on a metal substrate may be hardened by allowing the composition to stand undisturbed for one day in room temperature air to provide a tack-free continuous film over the substrate.

The term “autoweldable” when used with respect to a coating composition means that weldable metal plates coated with a hardened film of such coating composition may be welded together using automated arc welding equipment without having to remove the coating composition at the weld site to obtain a continuous, defect-free weld.

The term “autowelding” means the welding together of metal plates coated with a hardened shop primer film using automated arc welding equipment without having to remove the shop primer film at the weld site to obtain a continuous, defect-free weld.

The term “conductive” when used with respect to a material means that a dispersion of such material in a waterborne coating composition will provide increased conductivity or reduced volume resistivity such that metal substrates coated with such composition are rendered weldable or more readily weldable.

The term “defect-free” when used with respect to welded components joined through a weld bead means that the weld bead does not exhibit holes burned through the weld bead by elevated welding heat or localized regions within the weld bead where a weld failed to form.

The term “dispersed” when used with respect to an ingredient in a liquid coating composition means that the ingredient is suspended or otherwise substantially uniformly distributed throughout the composition. The term “dispersed” includes compositions that may undergo mild settling or other separation of components if allowed to stand undisturbed for lengthy periods of time (e.g., for one month or more) but which may be returned to a uniform state by stirring, e.g. using a paint stick, paddle or other hand tool, or by shaking using a paint shaker.

The terms “film-former” and “film-forming” when used with respect to a coating composition mean the composition contains a monomer, oligomer or polymer that can be applied to a substrate (if need be, together with a suitable plasticizer or coalescing solvent) and dried, crosslinked or otherwise hardened to form a tack-free continuous film over the substrate.

The term “latex” when used with respect to a waterborne coating composition means the composition contains a dispersion or emulsion of polymer particles formed in the presence of water and one or more secondary dispersing or emulsifying agents (e.g., a surfactant, alkali-soluble polymer or mixtures thereof) whose presence is required to form the dispersion or emulsion. The secondary dispersing or emulsifying agent is typically separate from the polymer after polymer formation. In some embodiments a reactive dispersing or emulsifying agent may become part of the polymer particles as they are formed.

The term “latex-coatable” when used with respect to a first liquid coating composition means that the composition, if applied to a substrate and dried, crosslinked or otherwise hardened to form a first tack-free continuous film over the substrate, can then be further coated with an at least 0.03 mm (at least 1 mil) wet thickness layer of an exterior latex paint like that employed in Comparison Example 1 which after air-drying for one day will provide a second tack-free continuous film free of visible inhomogeneities or other visible coating defects and sufficiently well adhered to the first film so as not to exhibit intercoat “tape-off” failure when evaluated using AS™ D3359-02, with Test Method A or B being used depending on whether the hardened second film is more, or not more, than 0.013 mm (5 mils) in thickness.

The term “low VOC” when used with respect to a liquid coating composition means that the coating composition contains less than about 10 wt. % volatile organic compounds, more preferably less than about 7 wt. % volatile organic compounds, and most preferably less than about 4 wt. % volatile organic compounds based upon the total liquid coating composition weight.

The term “one-part” when used with respect to a liquid coating composition means that the coating composition may be applied to a substrate as is and hardened to form a tack-free continuous film over the substrate, without requiring addition of another separately-packaged component such as a crosslinker or curing agent.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “primer” refers to a coating composition that may be applied to a metal substrate and dried, crosslinked or otherwise hardened to provide a tack-free continuous film sufficiently well adhered to the substrate so as not to exhibit “tape-off” failure when evaluated using AS™ D3359-02, with Test Method A or B being used depending on whether the hardened primer film is more, or not more, than 0.013 mm (5 mils) in thickness.

The term “shop primer” (sometimes also called a preconstruction primer) refers to a short-term or temporary primer composition for use on a bare metallic component prior to final assembly and application of a permanent primer and permanent protective or decorative topcoat. If the shop primer is applied in one or more layers to a bare metallic substrate and left uncoated without a topcoat, it may be incapable of withstanding extended exposure to corrosive conditions (e.g., one week of salt spray exposure) without visually objectionable deterioration or corrosion, but may provide adequate corrosion inhibition during such shorter time periods or less stringent conditions as may arise in a typical manufacturing operation.

The term “storage-stable” when used with respect to a liquid coating composition means that the coating composition may be stored in a covered container as a one-part, ready-to-use formulation for at least one month and preferably for at least six months at normal storage temperatures without undergoing unacceptable separation of components (viz., such that the composition cannot be returned to a uniform state by stirring, e.g. using a paint stick, paddle or other hand tool, or by shaking using a paint shaker), unacceptable interaction between ingredients, unacceptable change in viscosity, unacceptable change in color, or other significant loss in efficacy for its intended use.

The term “substantially free of” when used with respect to a component which may be found in a primer composition means containing less than about 1 wt. % of the component based on the composition weight.

The term “topcoat” refers to a coating composition which may be applied in one or more layers and which when dried or otherwise hardened provides a protective or decorative outermost finish layer on a coated object.

The term “unacceptable” when used with respect to a change in a characteristic or efficacy of a liquid coating composition refers to the performance requirements set or expected by an average end user of such composition.

The term “water-dispersible” when used with respect to a waterborne coating composition means the composition contains a polymer capable of being combined by itself with water, without requiring the use of a secondary dispersing or emulsifying agent, to obtain an aqueous dispersion or emulsion of polymer particles that is storage-stable for at least one month.

The term “waterborne” when used with respect to a coating composition means the composition contains (or before being hardened into a film, contained) solids dissolved or dispersed in water and optionally one or more other solvents or liquid carriers, with water representing the majority by weight of the non-solids portion of such coating composition.

The term “weldable” when used with respect to a metal substrate means that plates of such metal substrate may be joined to one another using manual arc-welding equipment. The term “weldable” when used with respect to a coating composition on a metal substrate means that plates of such substrate coated with a hardened, tack-free continuous film of such coating composition may be joined to one another using manual arc welding equipment without having to remove the coating composition at the weld site to obtain a continuous, defect-free weld. A weldable coating composition may also be referred to as a “weld-through” coating composition. Some weldable coating compositions are also autoweldable, but many are not.

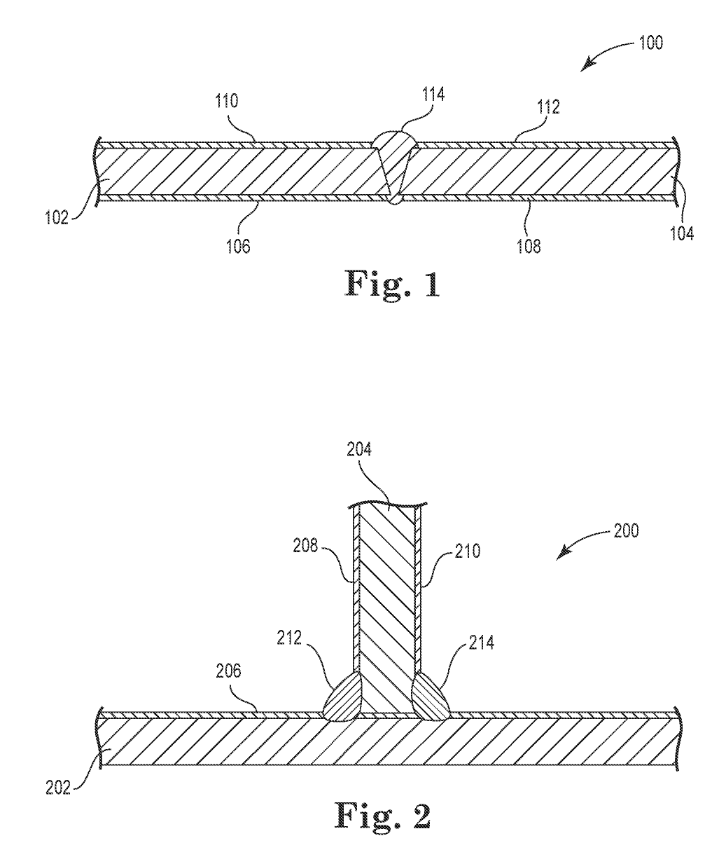

Referring to FIG. 1, a butt-welded metal article 100 includes generally abutting steel plates 102 and 104 whose undersides are respectively coated with air-dried waterborne coating composition films (e.g., latex primer films) 106 and 108 containing conductive material (e.g., carbonaceous material). The topsides of plates 102 and 104 are respectively coated with air-dried waterborne coating composition films (e.g., latex primer films) 110 and 112 containing conductive material (e.g., carbonaceous material). Primer films 106, 108, 110 and 112 may be the same as or different from one another, and preferably are all the same. A weld bead 114 joins plates 102 and 104, and may be formed without having to remove primer films 106, 108, 110 and 112 from areas at or proximate the weld site prior to welding. The primer films 106, 108, 110 and 112 desirably have sufficiently high electrical conductivity so that through-welding (viz., welding through the primer film) may be carried out using automated welding equipment without burning hole defects through the metal due to locally elevated welding heat and without localized failures to form a weld due to non-detection of the metal. The heat of welding may cause some volatilization or combustion of portions of films 106, 108, 110 and 112 adjacent weld bead 114. Desirably, however, the primer and particularly the binder is sufficiently heat-resistant so that visible evidence of such volatilization or combustion is limited to a relatively narrow zone extending less than 50 mm or less than 25 mm either side of the weld bead. Also, welding near or over the air-dried primer film desirably does not cause airborne emission of unsafe quantities of zinc and other heavy metals or other harmful substances from the primer. The conductive material desirably emits few or no objectionable byproducts, and desirably does not harm and may even improve the quality of the weld bead. After welding, slag and portions of primer films 106, 108, 110 and 112 on or near weld bead 114 may be removed so that the weld may be inspected for defects. This may be done using a variety of techniques including shot blasting, grinding and other suitable abrasive or ablative processes. After inspection, the weld and nearby de-primed regions may be re-primed with a conductive or non-conductive primer, preferably one that provides at least temporary corrosion inhibition. The completed assembled article may be coated with a suitable protective coating (e.g., a topcoat) that may provide more permanent corrosion inhibition or other desired surface and appearance features.

FIG. 2 shows a tee-welded metal article 200 which includes steel base plate 202 and perpendicularly-disposed steel leg plate 204. The underside of plate 202 may be coated with the disclosed conductive shop primer, may be coated with a conventional nonconductive primer, or may be uncoated. The embodiment shown in FIG. 2 has an uncoated underside. The topside of plate 202 and both major surfaces of plate 204 are respectively coated with dried (e.g., air-dried) waterborne coating composition primer films 206, 208 and 210 containing conductive material. Primer films 206, 208 and 210 may be the same as or different from one another, and preferably are all the same. Weld beads 212 and 214 join plates 202 and 204, and may be formed without having to remove primer films 206, 208 and 210 proximate the weld site prior to welding. As is the case for the embodiment shown in FIG. 1, the heat of welding may cause some volatilization or combustion of portions of films 206, 208 and 210 adjacent weld beads 212 and 214, and is limited to a relatively narrow zone either side of the weld bead as described above. After welding, slag and portions of primer films 206, 208 and 210 on or near weld beads 112 and 114 may be removed so that the welds may be inspected for defects as discussed above. After inspection, the weld and nearby de-primed regions may be re-primed and coated with topcoat as also discussed above.

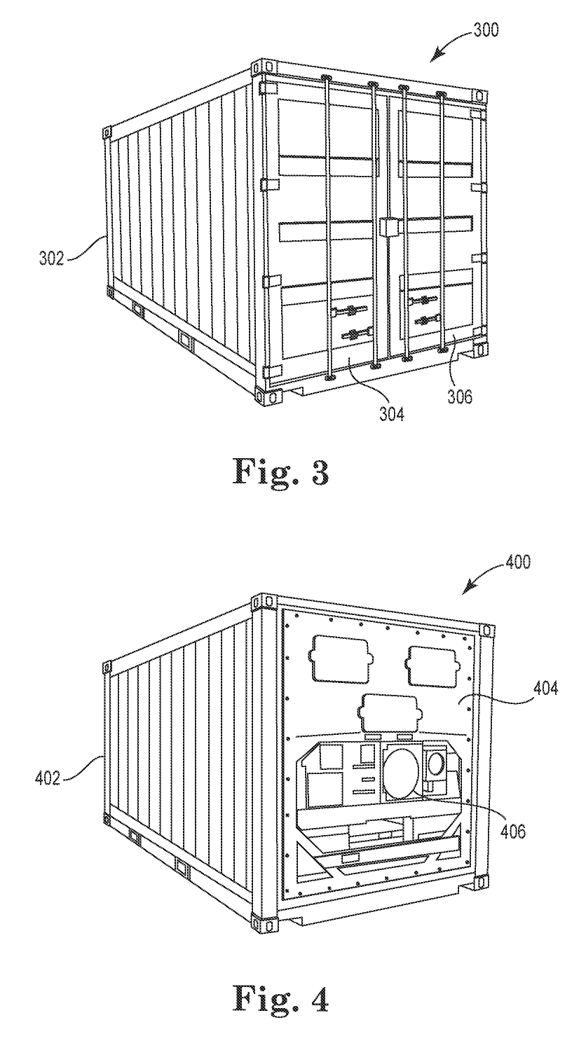

FIG. 3 and FIG. 4 show exemplary coated metal articles of the invention, namely a conventional shipping container 300 of welded construction including side 302 and end doors 304 and 306, and a refrigerated shipping container 400 of welded construction including insulated side 402 and insulated end panel 404 in which is mounted a refrigeration unit 406.

A variety of waterborne coating compositions may be used in the disclosed shop primer compositions. Preferred waterborne coating compositions include waterborne emulsion polymers (e.g., latex polymers), and water-dispersible or water-reducible polymers. The waterborne coating compositions preferably can readily be applied and air-dried or otherwise cured or hardened to provide an autoweldable film-forming primer coating containing the recited conductive material dispersed throughout a natural or synthetic binder. Exemplary waterborne emulsion polymers may be prepared as described for example in U.S. Patent Application Publication No. US 2007/0259166 A1 (Killilea et al.) or obtained from a variety of commercial sources. Preferred waterborne emulsion polymers include acrylic emulsions, ethylene vinyl acetate emulsions, polybutadiene emulsions, polyvinylidene emulsions, styrene acrylic emulsions, and vinyl acrylic emulsions. Such emulsions normally contain at least polymeric particles, water, and one or more emulsifiers. The waterborne emulsion polymer particles may include one or more functional groups capable of reacting with an external crosslinker, and such external crosslinker may also be a part of the disclosed shop primer compositions. The waterborne emulsion polymer particles may include hydroxyl-functional groups capable of reacting with an amino resin or polyisocyanate crosslinker Exemplary such amino resins include waterborne coating-compatible melamine, urea and glycoluril crosslinkers available from suppliers such as Cytec Industries Inc., including CYMEL™ 328 and CYMEL 383 aminoplast resins. Exemplary such polyisocyanates include waterborne coating-compatible polyisocyanate crosslinkers available from suppliers such as Bayer MaterialScience, including BAYHYDUR™ 304 and BAYHYDUR 3100 polyisocyanates. The waterborne emulsion polymer particles may also include carboxyl-functional groups capable of reacting with a waterborne coating-compatible polyepoxide crosslinker, or epoxy-functional groups capable of reacting with a waterborne coating-compatible epoxy curative. Exemplary such epoxy curatives include ANQUAMINE™ 721 water-reducible epoxy curative from Air Products and Chemicals, inc. and BECKOPDX™ EH 2179W/65WA water-reducible epoxy curative from Cytec Industries, Inc. Desirably however the disclosed shop primer compositions do not undergo a crosslinking or other curing reaction and instead merely coalesce into a uniform film and rapidly air dry (e.g., due to water loss) shortly after being applied. This can help discourage outgassing and other crosslinking or curing side effects which may cause spattering or other welding defects if welding is carried out before the applied shop primer has thoroughly cured.

Exemplary commercially available waterborne emulsion polymers include ALBERDINGK AC 2514, ALBERDINGK AC 25142, ALBERDINGK AC 2518, ALBERDINGK AC 2523, ALBERDINGK AC 2524, ALBERDINGK AC 2537, ALBERDINGK AC 25381, ALBERDINGK AC 2544, ALBERDINGK AC 2546, ALBERDINGK MAC 24, and ALBERDINGK MAC 34 polymer dispersions from Alberdingk Boley, Inc.; AQUAMAC 720 from Hexion Specialty Chemicals; EPS 2538 acrylic latex, EPS 2540 styrene acrylic latex and EPS 2725 acrylic latex emulsions from EPS Corp.; RESYN™ 7305 vinyl acrylic emulsion from Celanese Emulsion Polymers; RHOPLEX™ 3131-LO, RHOPLEX E-693, RHOPLEX E-940, RHOPLEX E-1011, RHOPLEX E-2780, RHOPLEX HG-95P, RHOPLEX HG-700, RHOPLEX HG-706, RHOPLEX PR-33, RHOPLEX TR-934HS, RHOPLEX TR-3349 and RHOPLEX VSR-1050 acrylic emulsions from Rohm and Haas Co.; RHOSHIELD™ 636 and RHOSHIELD 3188 polymer dispersions from Rohm and Haas Co.; JONCRYL™ 538, JONCRYL 1552, JONCRYL 1972, JONCRYL 1980, JONCRYL 1982, JONCRYL 1984 and JONCRYL 8383 acrylic emulsions from BASF Resins; NEOCRYL™ A-1127, NEOCRYL A-6115, NEOCRYL XK-12, NEOCRYL XK-90, NEOCRYL XK-98 and NEOCRYL XK-220 acrylic latex polymers from DSM NeoResins, Inc., and mixtures thereof.

Exemplary water-dispersible or water-reducible polymers may be prepared as described for example in U.S. Patent Application Publication No. US 2007/0259188 A1 (Wu et al.), or obtained from a variety of commercial sources. Preferred water-dispersible or water-reducible polymers include acrylics, alkyds, epoxies, polyesters, polyurethanes and vinylidene chloride copolymers. Such water-dispersible or water-reducible polymers normally contain at least polymeric particles, water, and a base (e.g., sodium hydroxide, potassium hydroxide, lithium hydroxide, calcium hydroxide, ammonia, triethylamine or dimethyl ethanol amine) or an acid (e.g., acetic, lactic, formic or propionic acid) that can react with appropriate functionality on the polymer to disperse it into water or dilute it with water. In a water-dispersible polymer such functionality normally will be in the form of acidic groups on the polymer backbone, and in a water-reducible polymer such functionality normally will be in the form of basic or acidic groups on the polymer backbone. The water-dispersible or water-reducible polymer particles may also include one or more functional groups capable of reacting with an external crosslinker, and such external crosslinker may also be a part of the disclosed shop primer compositions. Exemplary external crosslinkers include the crosslinkers described above in connection with waterborne lattices. As is the case however with the above-mentioned waterborne lattices, the water-dispersible polymer desirably does not undergo a crosslinking or other curing reaction and instead merely coalesces into a uniform film and rapidly air dries (e.g., due to water loss) shortly after being applied so as to discourage outgassing and other crosslinking or curing side effects which may cause spattering or other welding defects.

Exemplary commercially available water-dispersible or water-reducible polymers include JONCRYL™ acrylic copolymers from BASF Corporation; PARALOID™ WR-97 water-reducible acrylic resin from Dow Coating Materials; AROLON™ 562-G2-70 water-reducible acrylic resin from Reichhold Inc.; MAINCOTET™ HG-54D and RHOPLEX™ WL-96 waterborne acrylic resins from Rohm and Haas Co.; AQUAMAC™ thermoplastic styrene acrylic latex resin from Momentive Specialty Chemicals Inc.; CARBOSET™ CR-760 and CARBOSET CR-765 thermoplastic styrene-acrylic copolymer emulsions from Lubrizol Advanced Materials, Inc.; TEXICRYL™ acrylic and styrene acrylate dispersions from Scott Bader Inc.; TEXIGEL™ dispersions from Scott Bader Inc.; EPS 6208 water-reducible alkyd resin from EPS Corp.; ANCAREZ™ AR555 water-reducible epoxy resin from Air Products and Chemicals, Inc.; BECKOPDX™ EP386W/56WA water-reducible epoxy resin from Cytec Industries; EPS 3216 water-reducible polyester resin from EPS Corp.; EPS 4213 polyurethane dispersion from EPS Corp.; BAYHYDROL™ PR 240 polyurethane dispersion from Bayer MaterialScience; and POLIDENE™ vinylidene chloride copolymer emulsions from Scott Bader Inc.

Preferably the disclosed shop primers contain about 40 to about 80 wt. %, and more preferably about 60 to about 80 wt. % binder solids, based on total solids. If an external crosslinker is employed, the shop primers preferably contain about 5 to about 50 wt. % crosslinker, and more preferably about 10 to about 30 wt. % crosslinker, based on total binder solids.

A variety of conductive materials may be used in the disclosed shop primers. Exemplary conductive materials include particles, fibers, platelets and other shapes that can be uniformly dispersed throughout the waterborne coating composition. Preferred conductive materials may for example include carbon, calcium, cobalt, copper, iron, nickel and a variety of other less widely-used conductive materials. More expensive materials such as silver or antimony tin oxide may be used but desirably are coated onto a less expensive conductive or nonconductive substrate so as to reduce the total cost. Powdered elemental metals such as aluminum powder or zinc powder (viz., zinc dust) which may cause hydrogen evolution in the presence of water, binder instability, or other problems may be used but desirably are used in such small amounts or coated or otherwise treated so as to reduce the likelihood that such problems will arise. Preferably the chosen conductive material reduces or at least does not aggravate corrosion of primed but otherwise uncoated parts. Mixtures of conductive materials may be employed. Mixtures containing zinc conductive or nonconductive materials may for example be of interest due to the frequent use of zinc in current solvent-borne products and in the two-part Interplate Zero product discussed above, and due to a possible end-user expectation, even if unfounded or mistaken, that high zinc content would be desirable. Zinc however normally is employed at very high volume percentages in such compositions (e.g., at least about 40 volume percent or at least about 50 volume percent of the liquid coating composition). Metallic zinc has a number of disadvantages including a tendency to reduce stability (e.g., by causing gelation) when packaged in a one-part waterborne formulation. Accordingly if zinc is used, it desirably is employed as a part of a conductive mixture, together with at least one other conductive material having greater dried film conductivity than zinc at a given volume percent (viz., with at least one other conductive material whose conductive properties exhibit greater volumetric efficiency than zinc) or with at least one other conductive material having less tendency to cause instability in one-part formulations. Zinc desirably represents less than half the conductive material weight in such conductive mixture, preferably is used in an amount which by itself would not provide an autoweldable composition, and if present an elemental or other potentially reactive form, preferably represents less than about 1 wt. %, less than about 0.5 wt. %, or less than about 0.1 wt. % of the liquid coating composition. Zinc may be added in other forms, e.g., in a less reactive or nonreactive, semiconductive or nonconductive form such as zinc oxide, zinc silicate or zinc ethyl silicate, solubilized as need be using an appropriate acid or other water solubilizing aid.

Carbonaceous conductive materials are especially preferred. Exemplary carbonaceous materials include conductive carbon blacks such as acetylene blacks, furnace blacks produced from oil feed stocks, carbon fibers, graphite, as well as combination carbon-containing materials such as nickel-coated graphite powder. Exemplary commercially available carbonaceous materials include conductive carbons from AkzoNobel Polymer Chemicals including KETJENBLACK™ EC carbon blacks; conductive graphites, carbon fibers and carbon blacks available from Asbury Carbons; conductive carbons from Cabot Corp. including VULCAN™ XC conductive carbon black; conductive carbons from Columbian Chemicals Company including CONDUCTEX™ 975 Ultra and CONDUCTEX SC Ultra carbon blacks; conductive carbons from Continental Carbon including N120, N121. N234, LH30, N326, N330, N339, N343, N351 and N550 carbon blacks; conductive carbons from Lion Corporation; conductive carbons from Timcal Graphite & Carbon including ENSACO™ 150G, ENSACO 210G, ENSACO 250G, ENSACO 260G and ENSACO 350G conductive carbon blacks; and E-FILL™ nickel-coated graphite powders from Sulzer Metco Canada. Exemplary commercially available metallic materials include aluminum powders from Alcoa Aluminum Powder, from Eckart America and from Silberline Manufacturing Company; antimony-doped tin oxide powders from Milliken & Company including ZELEC™ ECP powders such as ZELEC ECP 1410-T powder; copper powders and flakes from Ferro Corporation including Copper Powder 8ED; copper powders from Sarda Industrial Enterprises; iron powders from Bayer Corporation, from BASF Corporation, from Cathay Pigments USA, from Haubach GmbH, from Hoover Color Corporation and from Toho Zinc Co. Ltd.; and nickel powders from Sulzer Metco Canada including E-FILL™ nickel powders. Exemplary commercially available coated metallic materials include CONDUCT-O-FILT™ coated conductive materials from Potters Industries. A variety of additional conductive materials are available from Reade Advanced Materials.

The electrical conductivity and loading level for the chosen conductive material desirably is sufficient to provide an autoweldable shop primer composition. The disclosed shop primers preferably have no or at most a low zinc content as discussed above, and preferably are free of or substantially free of cadmium and other harmful heavy metals which when welded may cause airborne emission of unsafe vapors, objectionable volatilization or combustion products, metal fume fever, or weld contamination.

The conductive material may for example represent at least about 0.5, at least about 1, at least about 2 or at least about 3 wt. % of the shop primer composition, and up to about 30, up to about 20, up to about 10 or up to about 7 wt. % of the shop primer composition. In general, lower amounts of carbonaceous conductive materials and higher amounts of metallic conductive materials may be employed, with the desired amount generally being selected empirically based on coating and welding performance. Expressed on a Pigment Volume Content (PVC) basis, the conductive material preferably represents about 2 to about 20% of the shop primer composition.

The disclosed shop primers normally will contain water, as a component of the latex or water-dispersible polymer and optionally as a further added ingredient. Preferably the coating composition contains sufficient water so that about 20 to about 80 wt. % solids and more preferably about 30 to about 60 wt. % solids are present when the composition is applied to a substrate.

The disclosed shop primers may comprise, consist essentially of or consist of the binder and conductive material, and may include other ingredients if desired. For example, the shop primers may include one or more corrosion inhibitors. Representative such corrosion inhibitors inorganic or organic materials including aluminum triphosphate, barium borophosphate, calcium phosphosilicate, calcium silicate, strontium phosphate, zinc phosphate, zinc oxide and mixtures thereof. Preferably the shop primers contain about 1 to about 20 wt. % and more preferably about 1 to about 10 wt. % corrosion inhibitor, based on total solids.

The disclosed shop primers may include one or more coalescents which may help reduce viscosity, aid wetting or promote or aid film formation. Plasticizers or solvents that promote formation of a continuous film are especially desirable coalescents. Exemplary coalescents include glycol ethers, alcohols, and the coalescents described in U.S. Pat. No. 6,762,230 B2 (Brandenburger et al.). Representative glycol ethers include ethylene glycol, ethylene glycol methyl ether, ethylene glycol ethyl ether, ethylene glycol monobutyl ether, ethylene glycol-2-ethylhexyl ether, propylene glycol, propylene glycol methyl ether, propylene glycol ethyl ether, propylene glycol monobutyl ether, propylene glycol-2-ethylhexyl ether, diethylene glycol, diethylene glycol methyl ether, diethylene glycol ethyl ether, diethylene glycol monobutyl ether, diethylene glycol-2-ethylhexyl ether, dipropylene glycol, dipropylene glycol methyl ether, dipropylene glycol ethyl ether, dipropylene glycol monobutyl ether, dipropylene glycol-2-ethylhexyl ether, and mixtures thereof. Mixtures may provide better wetting on some substrates than will be obtained when only a single glycol ether is employed. Selection of such mixtures may be made empirically. Preferably the shop primers contain about 1 to about 40 wt. % and more preferably about 15 to about 25 wt. % glycol ether or other coalescent, based on total solids.

The disclosed coating compositions may optionally include one or more initiators, coinitiators or synergists such as those described in U.S. Patent Application Publication No. 2006/0135686 A1. Exemplary initiators include photoinitiators, thermal initiators, and catalysts for auto-oxidative cure.

The disclosed shop primers may contain a variety of other adjuvants that will be familiar to persons having ordinary skill in the art. Representative adjuvants are described in Koleske et al., Paint and Coatings Industry, April, 2003, pages 12-86, and may include surfactants (e.g., in addition to those which may be present in a latex binder), pigments, colorants, dyes, dispersants, defoamers, thickeners (e.g., hydrophobic ethoxylated urethane resin (HEUR) thickeners, and hydrophobically-modified, alkali-soluble or alkali-swellable emulsion (HASE) thickeners), heat stabilizers, leveling agents, biocides, mildewcides, anti-cratering agents, curing indicators, plasticizers, nonconductive materials, extenders, sedimentation inhibitors, waxes, ultraviolet light absorbers, optical brighteners, flatting agents, mar and abrasion additives and the like. The types and amounts of adjuvants typically will be empirically selected for use with the particular application and equipment at a given manufacturing site.

The disclosed shop primers may also be formulated by modifying commercially available shop primer formulations supplied by companies including Akzo Nobel, Chugoku Marine Paints, Ltd. (CMP), Hempel A/S, Jotun and Kansai Paint Co. Ltd., or by adapting or by modifying as need be commercially available conductive or electromagnetic shielding paint formulations supplied by companies or suppliers including Desco Industries Inc., Less EMF Inc. and YSHIELD EMR Protection. As a general guide, the binder and solvents in such formulations should be adapted as need be to provide a one-part waterborne coating composition, the zinc level (if present, especially if it is metallic zinc) should be reduced sufficiently and if need be eliminated so that the one-part composition will be storage-stable, and an appropriate alternative conductive material (e.g., a non-zinc-containing conductive material, and desirably a conductive material that provides conductivity as good as or better than that provided by metallic zinc at a comparable weight level) should be added in an amount sufficient to provide an autoweldable conductive primer formulation.

The disclosed shop primer compositions may be applied to a variety of metal substrates including steel, iron, aluminum, zinc and alloys thereof. The compositions may be applied using a variety of methods that will be familiar to those skilled in the art, including spraying, electrostatic coating, brushing, roller coating, flood coating and dipping. The compositions may be applied at a variety of wet film thicknesses. Preferably the wet film thickness is such as to provide a dry film thickness of about 1 to about 100 lam and more preferably about 2 to about 20 μm for the hardened primer. The applied primer coating may be hardened using a variety of drying techniques devices that will be familiar to persons having ordinary skill in the art, including air drying and forced drying. When forced drying is used, exemplary oven temperatures of about 30° to about 205° C. and heating times less than 60 minutes, less than 30 minutes, less than 15 minutes, less than 10 minutes, less than 6 minutes or less than 5 minutes may be employed. For example, the heating time may be about 1 to about 60 minutes.

Welding can be carried out using techniques and materials that will be familiar to persons having ordinary skill in the art. Following welding the disclosed shop primer may be left in place or removed (e.g., by shot blasting) from at least the region near the weld, for example to assist in inspecting the weld. Following inspection and any other needed component assembly, the shop-primed welded article may for example be overcoated with an additional, and typically thicker, corrosion-inhibiting protective primer layer. Representative such additional primers are available from suppliers including Akzo Nobel, Chugoku Marine Paints, Ltd (CMP), Hempel A/S, Kansai Paint Co. Ltd., KCC Marine & Protective Coatings and Valspar Corporation. The resulting primed coated metal article may for example have a continuous corrosion-inhibiting outer primer coating, which coating contacts and lies atop the underlying metal at weld beads and in zones extending less than for example 100 mm, 50 mm or 25 mm either side of the weld bead, and contacts and lies atop the shop primer outside such zones. The primed coated metal article may for example be further overcoated with a suitable topcoat composition. Representative topcoats are available from suppliers including the additional primer suppliers mentioned above.

The disclosed coated articles may be used for a variety of purposes. Representative end-use applications include refrigerated containers and unrefrigerated shipping containers (e.g., dry cargo containers) from suppliers or manufacturers including China International Marine Containers (CIMC), Graaff Transportsysteme Gmbh, Maersk Line and others that will be familiar to persons having ordinary skill in the art, chassis, trailers including semitrailers, rail cars, truck bodies, ships and other vessels, bridges, building skeletons, and other prefabricated or site-fabricated metal articles needing temporary indoor or outdoor corrosion inhibition during fabrication. Additional uses include metal angles, channels, beams (e.g., I-beams), pipes, tubes, plates and other components that may be welded into these and other metal articles.

The invention is further illustrated in the following non-limiting examples, in which all parts and percentages are by weight unless otherwise indicated.

### Example 1

The ingredients shown below in Table 1 were combined in the listed order and mixed to provide a uniform dispersion:

TABLE 1

| Ingredient or Step | Amount, parts |
|---|---|
| Styrene acrylic emulsion (40% solids) | 280 |
| Polyether modified polysiloxane defoamer (60% solids) | 7 |
| Nonionic surfactant (50% in 2-butoxyethanol) | 3.5 |
| Ethylene glycol monobutyl ether | 6 |
| Water | 62 |
| VULCAN ™ XC-72R conductive carbon black | 37 |
| Aluminum triphosphate | 37 |
| (The above ingredients constituted a grind to which was | |
| added the following letdown): | |
| Styrene acrylic emulsion (40% solids) | 331 |
| Water | 24 |
| Ammonia (26%) | 4.5 |
| Ester alcohol coalescent | 8.5 |
| Defoamer (100% solids) | 4.5 |
| Ethylene glycol monobutyl ether | 64 |
| Sodium Nitrate (10%) | 23 |

The resulting conductive black primer was spray-applied to a bare steel substrate and air-dried for testing. The hardened primer conductivity was verified by topcoating the primer with a cathodic electrodepositable paint. This cathodic coating result indicated that the coating was sufficiently conductive so that the coated steel panels should be autoweldable using automated welding equipment without holes or failures to form a weld due to non-detection of the metal.

### Example 2

The ingredients shown below in Table 2 were combined in the listed order and mixed to provide a uniform dispersion:

TABLE 2

| Ingredient or Step | Amount, parts |
|---|---|
| Styrene Acrylic emulsion (40% solids) | 707.0 |
| DISPERBYK ™ 190 wetting agent (Byk-Chemie | 2.28 |
| GmbH) | |
| Polyether modified polysiloxane defoamer (60% solids) | 2.72 |
| Aqueous ammonia | 3.32 |
| Titanium dioxide | 53.2 |
| ZELEC ™ ECP 1410-T electroconductive antimony- | 66.8 |
| doped tin oxide powder (Milliken and Company) | |
| (The above ingredients constituted a grind to which was | |
| added the following letdown): | |
| Defoamer (100% solids) | 3.14 |
| Ethylene glycol monobutyl ether | 46.0 |
| Nonionic surfactant | 2.5 |
| Ester alcohol coalescent | 2.94 |
| Water | 87.4 |
| ACRYSOL ™ RM-825 nonionic urethane rheology | 1.14 |
| modifier (Rohm & Haas) | |
| Sodium Nitrate (10%) | 17.47 |

The resulting conductive white primer was spray-applied to a bare steel substrate and air-dried for testing. The hardened primer conductivity was verified by topcoating the primer with a cathodic electrodepositable paint. This cathodic coating result indicated that the coating was sufficiently conductive so that the coated steel panels should be autoweldable using automated welding equipment without holes or failures to form a weld due to non-detection of the metal.

### Example 3

Interplate Zero two-part shop primer from Akzo Nobel could be modified to provide a one-part shop primer by replacing the zinc powder in Part B with sufficient carbon black and dispersant to provide about 7 to 10 wt. % conductive carbonaceous material in the final formulation. Parts A and B could be mixed and the formulation further modified if premature gelation is observed. The mixture could be applied to bare metal and allowed to dry to provide a weldable and desirably autoweldable coated metal article.

### Example 4

HEMPEL™ ZS 1589 zinc silicate shop primer from Hempel A/S could be modified by replacing the zinc powder in the Base portion with sufficient carbon black and dispersant to provide about 7 to 10 wt. % conductive carbonaceous material in the final formulation. The binder desirably also would be modified and the solvents removed to convert the formulation to a waterborne version. The Base and Liquid portions could be mixed, applied to bare metal and allowed to dry to provide a weldable and desirably autoweldable coated metal article.

### Example 5

YSHIELD™ HSF54 EMR shielding paint from YSHIELD EMR-Protection is said to contain among other things water, acrylic binder, graphite, carbon black and carbon fibers, and to provide “Excellent adhesion to many interior and exterior surfaces and substrates like old emulsion paint layers, sheetrock, cement, plaster, masonry, wood, etc.” It does not appear to have been recommended for use on metal, and would not be expected to provide an electromagnetic radiation shielding benefit if so used. A 0.1 to 0.15 mm thick film of the paint was applied to bare steel panels. A minor amount of cratering was observed. The hardened paint conductivity was verified by electrodepositing a topcoat layer of cathodic electrodepositable paint. This cathodic coating result indicated that the coating may be sufficiently conductive so that the coated steel panels could be welded using automated welding equipment.

### Example 6

MUKI™ AC shop primer from Jotun is a waterborne one-part coating material said to contain among other things trizinc bis(orthophosphate) and zinc oxide. Tests performed by attempting to electrocoat a cathodic electrodepositable paint on a 0.01 mm dry film thickness coating of MUKI AC primer on cold rolled steel panels indicated that the primer was not sufficiently conductive to permit panel welding through the primer using automated welding equipment. MUKI AC primer could be modified by replacing the zinc-containing materials in the formulation with sufficient carbon black and dispersant to provide about 7 to 10 wt. % conductive carbonaceous material in the final formulation. The formulation could be applied to bare metal and allowed to dry to provide a weldable and desirably autoweldable coated metal article.

### Example 7

CuPro-Cote™ conductive paint from Less EMF Inc. is said to have been developed as a radio frequency interference (RFI) and electromagnetic field (EMF) shield for plastic electronic equipment housings. A 0.13 to 0.15 mm thick film of the paint was applied to bare steel panels, followed by application of either a cathodic electrodepositable paint or the exterior latex paint used in Comparison Example 1. The electrodepositable paint was successfully applied but bubbling was observed with the latex paint. The product could be modified by altering the binder or removing adhesion-inhibiting components as need be to make the modified formulation latex-coatable.

### Comparison Example 1

A brown acrylic exterior latex (VALSPAR AQUAGUARD™ paint from Valspar Corporation) was measured into lined metal paint cans. Zinc dust was dispersed gently into each container at 0, 1, 2, 6, 10, 25, 50, and 75 wt. % based on the total coating composition weight. All the zinc-containing compositions skinned over within one hour and those with about 10 wt. % or more zinc gelled sufficiently that their viscosity could no longer be measured using a Zahn cup. The skin was brittle rather than rubbery as might be observed within an aged, partially-filled paint can. The skin thickness did not appear to vary even at the highest zinc levels, but the high level samples did have a distinct gray-black appearance. When allowed to stand overnight, all the zinc-containing compositions had gelled at least somewhat throughout, with those containing about 10 wt. % or more zinc forming an at least semisolid mass. The zinc-free composition remained free of skin and gelation even after standing overnight.

### Comparison Example 2

Statguard™ conductive acrylic paint from Desco Industries Inc. is said to produce controlled dissipation of static electrical charges when applied to concrete floors or to previously painted surfaces. An approximately 0.1 mm thick film of the paint was applied to bare steel panels using several thin coats, each of which appeared to have a low solids content. An attempt was made to apply a cathodic electrodepositable paint to the coated panels, but there appeared to be insufficient conductivity to carry out electrodeposition. The paint film is not likely to be autoweldable.

Having thus described the preferred embodiments of the present invention, those of skill in the art will readily appreciate that the teachings found herein may be applied to yet other embodiments within the scope of the claims hereto attached.

What is claimed is:

1. A coated metal component comprising a weldable metal substrate having thereon a shop primer layer comprising a one-part, storage-stable, air-dryable, latex-coatable waterborne film-forming coating composition having dispersed therein sufficient conductive material to provide an autoweldable hardened shop primer layer.

2. A coated metal component according to claim 1 wherein the coating composition comprises a waterborne emulsion polymer.

3. A coated metal component according to claim 2 wherein the emulsion polymer comprises acrylic, ethylene vinyl acetate, polybutadiene, polyvinylidene, styrene acrylic or vinyl acrylic polymer articles.

4. A coated metal component according to claim 1 wherein the coating composition comprises a water-dispersible polymer.

5. A coated metal component according to claim 4 wherein the water-dispersible polymer comprises acrylic, alkyd, epoxy, polyester or polyurethane polymer particles.

6. A coated metal component according to claim 1 wherein the coating composition does not undergo a crosslinking or other curing reaction and instead coalesces into a uniform film and rapidly air dries shortly after being applied.

7. A coated metal component according to claim 1 wherein the conductive material comprises a carbonaceous material.

8. A coated metal component according to claim 7 wherein the carbonaceous material comprises particles, fibers or platelets.

9. A coated metal component according to claim 7 wherein the carbonaceous material comprises carbon black, graphite or carbon fiber.

10. A coated metal component according to claim 1 wherein the conductive material comprises calcium, cobalt, copper, iron, nickel or mixture thereof.

11. A coated metal component according to claim 1 wherein the coating composition is substantially free of zinc.

12-13. (canceled)

14. A coated metal component according to claim 1 wherein the coating composition also contains at least one corrosion inhibitor.

15. A coated metal component according to claim 14 wherein the corrosion inhibitor comprises aluminum triphosphate, barium borophosphate, calcium phosphosilicate, calcium silicate, zinc phosphate or mixture thereof.

16. A coated metal component according to claim 1 wherein the coating composition also contains at least one coalescent.

17. A coated metal component according to claim 16 wherein the coalescent comprises a glycol ether or an alcohol.

18. A coated metal component according to claim 1 wherein the substrate comprises steel, iron, aluminum, zinc or alloy thereof.

19. A coated metal component according to claim 1 wherein the component comprises a prefabricated metal article requiring temporary corrosion inhibition during fabrication.

20. A coated metal component according to claim 1 wherein the component comprises a refrigerated or unrefrigerated shipping container, chassis, trailer, rail car, truck body or vessel.

21-24. (canceled)

25. A coated metal article comprising a plurality of metal components having thereon a corrosion-inhibiting primer film comprising a hardened waterborne binder having dispersed therein conductive material, the components being joined together by one or more defect-free welds through the hardened primer, and wherein if the conductive material comprises conductive zinc material, the amount thereof is sufficiently low so that the unhardened primer is a storage-stable liquid coating composition.

26. A method for assembling a metal article, which method comprises:
a) providing a plurality of metal components having thereon a corrosion inhibiting primer film comprising a hardened waterborne binder and having dispersed therein sufficient conductive material so that the components may be autowelded through the primer, wherein if the conductive material comprises conductive zinc material, the amount thereof is sufficiently low so that the unhardened primer is a storage-stable liquid coating composition, and
b) welding the components together.
